(19) United States
(12) Patent Application Publication
(10) Pub. No.: US 2025/0196757 A1
(43) Pub. Date: Jun. 19, 2025

(54) TRAILER STATUS INDICATOR LIGHTS

(71) Applicant: R.A. PHILLIPS INDUSTRIES, INC., Santa Fe Springs, CA (US)

(72) Inventor: Peter John Pless, III, South Ogden, UT (US)

(21) Appl. No.: 18/982,822

(22) Filed: Dec. 16, 2024

Related U.S. Application Data
(60) Provisional application No. 63/610,841, filed on Dec. 15, 2023.

(51) Int. Cl. B60Q 1/26; B60Q 1/50; B60R 16/03

(52) U.S. Cl. CPC B60Q 1/2615; B60Q 1/543; B60R 16/03

(57) ABSTRACT

A status indicator light assembly for a trailer includes a housing having a mounting member having an interface surface configured to face a portion of the trailer, a support member connected to the mounting member, and at least one opening in the at least one support member. The status indicator light assembly also includes at least one status light accommodated in the at least one opening of the housing and a wiring harness having one end coupled to the at least one status light and another end configured to be coupled to an electrical system of the trailer.

### CROSS-REFERENCE TO RELATED APPLICATION(S)

The present application claims priority to and the benefit of U.S. Provisional Application No. 63/610,841, filed Dec. 15, 2023, the entire content of which is incorporated herein by reference.

### BACKGROUND

### 1. Field

Aspects of embodiments of the present disclosure relate to monitoring systems for trucks, trailers, and other motor vehicles.

### 2. Description of the Related Art

Currently, many trailers are equipped with a refrigeration unit (also referred to as a reefer) to transport perishable goods such as produce, frozen foods, and meat products, which need to be maintained at certain temperatures. During transport, the reefer may control one or more environmental conditions (e.g., temperature, humidity, air quality, and the like) of the interior space of the trailer. It is important for the driver of vehicle to be able to monitor the status of the reefer as a non-functioning reefer could lead to spoilage of cargo and monetary loss.

Vehicle reefers commonly have control panels outside of the trailer that allow for electrical connections to be made to monitor the status of the reefer. Status indicators are often either affixed to the reefer or to the front of the trailer, which are not visible to a driver while driving.

Similarly, most modern trailers are equipped with an automatic tire inflation and tire pressure monitoring system (ATIS), which is capable of monitoring tire pressure in real time and adding or removing a sufficient amount of air to the tire when its pressure drops below or rises above a certain value. An ATIS indicator light may illuminate for an extended period of time when there is a leaking tire or a leaking tire inflation system component. Similar to the reefer status indicator, the ATIS indicator is also generally mounted on the front of the trailer and is thus not visible to the driver when in the cab of the truck.

As such, the driver/operator of a tractor towing the trailer equipped with a reefer and/or ATIS may not be able to monitor the status of the reefer and/or the ATIS while driving as the driver does not have a direct line-of-sight to the corresponding indicator light(s) from the cab of the tractor. This can create a safety hazard and could lead to the driver receiving a traffic citation for improperly working equipment.

The above information disclosed in this Background section is only for enhancement of understanding of the background of the invention and therefore it may contain information that does not constitute prior art.

### SUMMARY

The present application relates to various embodiments of a status indicator light assembly for a trailer. In one embodiment, the status indicator light assembly includes a housing having a mounting member having an interface surface configured to face a portion of a corner of the trailer, a support member connected to the mounting member, and an opening in the support member. Additionally, the status indicator light assembly includes at least one status light accommodated in the opening of the housing and a wiring harness having one end coupled to the at least one status light and another end configured to be coupled to an electrical system of the trailer.

The interface surface may be a curved surface.

The curved surface may be a radiused surface.

The interface surface may be an angled surface.

The status indicator light assembly may also include at least one visor accommodated in the at least one opening. The visor covers at least a portion of an outer side of the status light.

The status indicator light assembly may also include a flexible gasket configured to be coupled to the interface surface of the housing.

The flexible gasket may be an accordion gasket

The flexible gasket may taper from a thicker front-end portion to a thinner rear-end portion.

The flexible gasket may be hollow.

The status indicator light assembly may include two or more status lights.

The two or more status lights may include a green light and a red (or amber) light.

The support member may include two or more semi-cylindrical projections, and each semi-cylindrical projection may support one of the status lights.

The status indicator light assembly may include two or more fastener openings in the mounting flange of the housing.

The support member of the housing may include a substantially planar surface and a tapered surface extending rearward from the substantially planar surface.

The present disclosure also relates to various embodiments of a method of retrofitting a trailer to include a status light assembly. In one embodiment, the method includes fastening the mounting member of the housing to the corner of the trailer such that the at least one status light is oriented in a forward direction toward the tractor and connecting one end of the wiring harness to an electrical system of the trailer.

The electrical system may be a reefer or an automatic tire inflation system (ATIS).

Fastening may include riveting the mounting member to the corner of the trailer.

The interface surface of the mounting member may substantially conform to the corner of the trailer.

A shape of the interface surface is different than a shape of the corner, and the method may include installing a flexible gasket between the interface surface of the housing and the corner of the trailer.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features or tasks may be combined with one or more other described features or tasks to provide a workable status indicator light assembly for a trailer.

### BRIEF DESCRIPTION OF THE DRAWINGS

The accompanying drawings, together with the specification, illustrate exemplary embodiments of the present invention, and, together with the description, serve to explain aspects of embodiments of the present invention. The above and other features and aspects of the present invention will become more apparent by the following detailed description of exemplary embodiments thereof with reference to the attached drawings, in which:

FIG. 1 is a schematic perspective view of a status indicator light assembly according to embodiments of the present disclosure installed on a trailer being towed by a tractor;

FIGS. 2A-2E depict a front perspective view, a rear perspective view, a front view, a side view, and a top view, respectively, of a status indicator light assembly including a single status light according to an embodiment of the present disclosure;

FIGS. 3A-3C depict a front perspective view, a front view, and a rear perspective view, respectively, of a status indicator light assembly including a signal status light and a gasket according to another embodiment of the present disclosure;

FIGS. 3D-3E depict a front perspective view and a rear perspective view, respectively, of the gasket according to the embodiment of the status indicator light assembly of FIGS. 3A-3C;

FIGS. 4A-4D depict a front perspective view, a front view, a side view, and a top view, respectively, of a status indicator light assembly including two status lights according to another embodiment of the present disclosure;

FIGS. 5A-5C depict a front perspective view, a front view, and a rear perspective view, respectively, of a status indicator light assembly including two status lights and a gasket according to another embodiment of the present disclosure;

FIGS. 5D-5E depict a front perspective view and a rear perspective view, respectively, of the gasket according to the embodiment of the status indicator light assembly of FIGS. 5A-5C;

FIGS. 6A-6D depict a front perspective view, a front view, a side view, and a top view, respectively, of a status indicator light assembly including three status lights according to another embodiment of the present disclosure; and

FIGS. 7A-7B depict a front perspective view, a top view and a cross-sectional view, respectively, of a status indicator light assembly including three status lights and a gasket according to another embodiment of the present disclosure.

### DETAILED DESCRIPTION

The present disclosure relates to various embodiments of a status indicator light assembly that is configured to be mounted onto the front corner of a trailer and oriented in a forward direction toward the cab of a truck. According to some embodiments, the status indicator light assembly is configured to perform real-time monitoring of one or more electrical components in the trailer (e.g., a reefer, an automatic tire inflation system (ATIS), etc.) and includes one or more status lights that indicate the status of the one or more electrical components in the trailer. The status indicator light assembly may also include a wire/cable for electrically connecting the one or more lights to the nosebox of the trailer (e.g., in the case of ATIS), the back of the reefer, and/or the like. The status indicator further includes a housing that encapsulates the one or more status lights and has a curved mounting flange that may be mounted to a curved corner of the trailer. The status indicator light assembly may be mounted such that the one or more status lights are facing the forward direction to allow them to be visible to the driver through the side view mirror, thus allowing the driver to easily monitor the status of various electrical equipment in the trailer while the vehicle is in motion. The present disclosure also relates to various embodiments of a method of retrofitting a trailer to include a status indicator light assembly.

Hereinafter, embodiments of the present invention will be described more fully with reference to the accompanying drawings, in which, exemplary embodiments of the present invention are shown. As those skilled in the art would realize, the described embodiments are susceptible to various modifications and alternative forms without departing from the spirit or scope of the present invention. For clarity of the description of the present invention, some elements or features not required for the complete understanding of the present invention may be omitted.

Like reference numerals in the drawings denote like elements, and repeated descriptions thereof may be omitted.

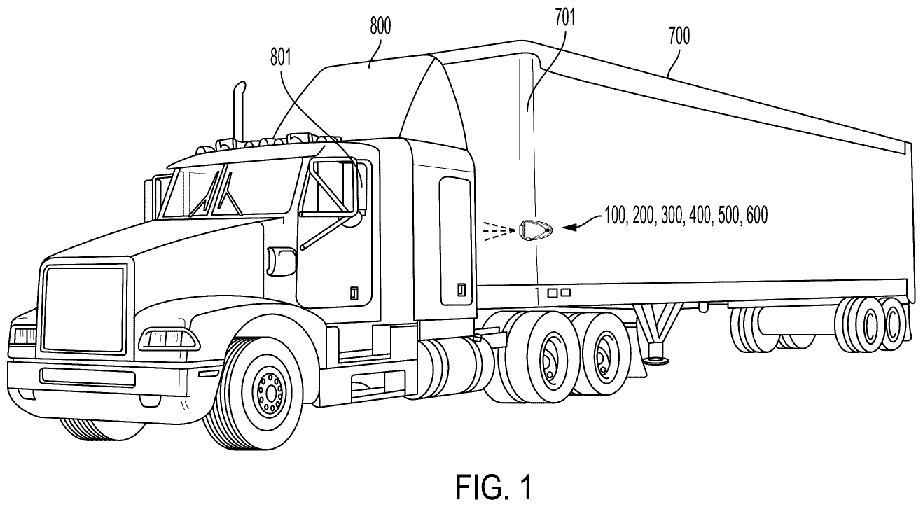

FIG. 1 depicts a status indicator light assembly 100, 200, 300, 400, 500, or 600 according to one embodiment of the present disclosure coupled to a front corner 701 (e.g., a driver side front corner) of a trailer 700 towed by a tractor 800. The status indicator light assembly 100, 200, 300, 400, 500, or 600 is electrically connected to one or more electrical systems of the trailer 700, such as a refrigeration unit (reefer) or an automatic tire inflation system (ATIS), and the status indicator light assembly 100, 200, 300, 400, 500, or 600 is configured to illuminate a light in response to the detection of an issue (e.g., a failure, an error, or other irregularity or abnormality) with the electrical system of the trailer 700. As illustrated in FIG. 1, the status indicator light assembly 100, 200, 300, 400, 500, or 600 is configured (e.g., positioned and oriented) such that light emitted from one or more lights of the status indicator light assembly 100, 200, 300, 400, 500, or 600 in response to an issue with one of the electrical systems of the trailer 700 is visible by a driver of the tractor 800 looking in one of the side view mirrors 801 of the tractor 800. That is, the status indicator light assembly 100, 200, 300, 400, 500, or 600 is configured such that the light emitted from one or more lights of the status indicator light assembly 100, 200, 300, 400, 500, or 600 extends forward from the trailer 700 toward the tractor 800 and strikes one of the side view mirrors 801 of the tractor 800. In one or more embodiments, the height of the status indicator light assembly 100, 200, 300, 400, 500, or 600 on the trailer 700 may be substantially equal to the height of the side view mirrors 801 on the tractor 800. Accordingly, the status indicator light assembly 100, 200, 300, 400, 500, or 600 enables the driver to easily monitor the status of various electrical equipment in the trailer 700 in real-time while the tractor-trailer is in motion.

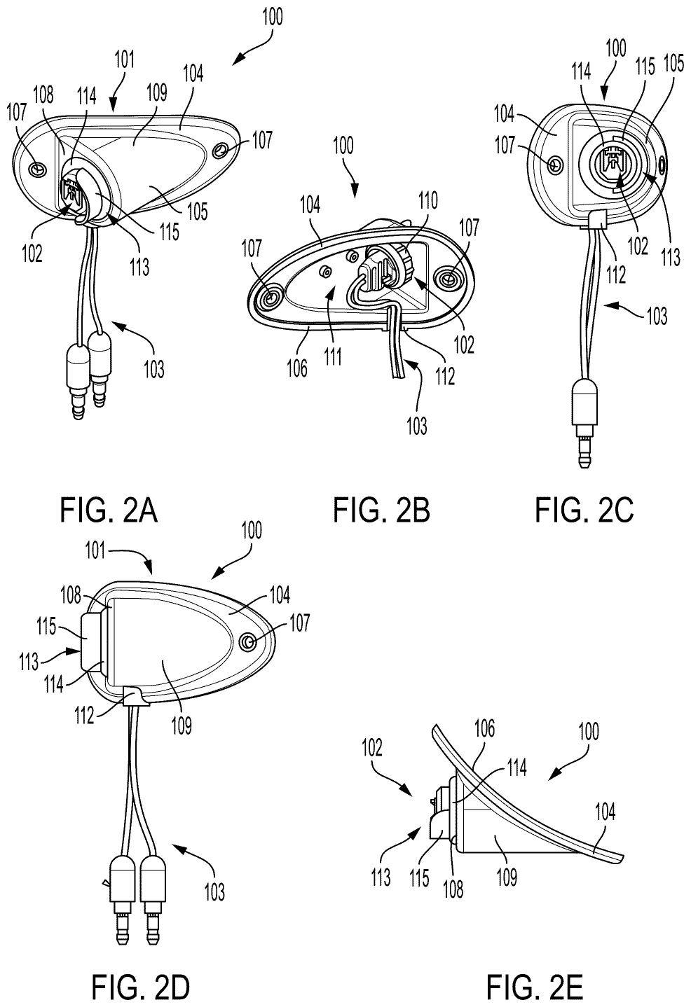

With reference now to FIGS. 2A-2E, a status indicator light assembly 100 according to one embodiment includes a housing 101, a status light 102 supported by the housing 101, and a wiring harness 103 connected to the status light 102. In the illustrated embodiment, the housing 101 includes a mounting member 104 (e.g., a mounting flange) and a support member 105 connected to the mounting member 104. The mounting member 104 includes an inner curved interface surface 106 configured to face toward one of the front corners 701 of the trailer 700. In one or more embodiments, when the status indicator light assembly 100 is installed on one of the corners 701 of the trailer 700, the curved interface surface 106 may directly or indirectly contact one of the corners 701 of the trailer 700. In one or more embodiments, the curved interface surface 106 of the housing 101 may be configured to conform (or substantially conform) to one of the front corners 701 of the trailer 700 (e.g., the driver side front corner 701 of the trailer 700). That is, in one or more embodiments, the configuration (e.g., the shape and size) of the curved interface surface 106 may match or substantially match the configuration (e.g., shape and size) of one of the corners 701 of the trailer 700. In one or more embodiments, the curved interface surface 106 may be a radiused surface. In one or more embodiments, the curved interface surface 106 may have a compound curvature or a complex curvature depending, for instance, on the shape of the corner 701 of the trailer 700 on which the housing 101 is intended to be used. Because trailers may be manufactured with different corner curvatures, the housing 101 may be provided in different versions, each having a curved interface surface 106 that matches or substantially matches the corner curvature of the trailer 700 for which it is intended.

In the illustrated embodiment, the housing 101 includes a plurality of openings (e.g., holes) 107 in the mounting member 104 that are configured to accommodate fasteners (e.g., rivets) securing the housing 101 to the trailer 700. Although in the illustrated embodiment the housing 101 includes a pair of openings 107 (a front opening and a rear opening), in one or more embodiments the housing 101 may include any other suitable number and arrangement of openings 107 for receiving fasteners to secure the housing 101 to the trailer 700.

In the illustrated embodiment, the support member 105 includes a substantially planar surface 108 extending outward from the mounting member 104, and a tapered surface 109 extending rearward from the substantially planar surface 108. An opening 110 (e.g., a hole) is defined in the substantially planar surface 108 of the support member 105. The opening 110 accommodates the status light 102. The support member 105 also defines an interior chamber or compartment 111 configured to house a portion of the status light 102 and a portion of the wiring harness 103 connected to the status light 102. For instance, in the illustrated embodiment, the substantially planar surface 108 and the tapered surface 109 together form the interior chamber 111.

In the illustrated embodiment, the housing 101 includes a conduit or channel 112 that places the interior chamber 111 in communication with the exterior of the housing 101. The conduit 112 defines a pathway through which the wiring harness 103 passes from the interior chamber 111 to the exterior of the status indicator light assembly 100. In this manner, the conduit 112 enables the wiring harness 103 to be connected at one end to the status light 102 and at the other end to one or more electrical systems of the trailer 700, such as the reefer or the ATIS. Although in the illustrated embodiment the conduit 112 is along a lower portion of the mounting member 104 below the support member 105, in one or more embodiments the conduit 112 may be in any other suitable location, such as along an upper portion of the mounting member 104 above the support member 105 or rearward of the support member 105.

In the illustrated embodiment, the status indicator light assembly 100 also includes a visor 113 configured to cover or conceal a portion of the status light 102. The visor 113 is configured to direct the light emitted from the status light 102 forward toward the tractor 800 and/or to prevent (or at least mitigate) light emitted from the status light 102 from extending laterally outward away from the trailer 700, which could otherwise obstruct or impair the vision of drivers driving in the opposite direction (i.e., opposing traffic). In the illustrated embodiment, the visor 113 is supported on the support member 105 of the housing 101. In one or more embodiments, at least a portion of the visor 113 may be accommodated in the opening 110 in the support member 105. In the illustrated embodiment, the visor 113 includes an annular flange 114 accommodated in the opening 110 and a semi-annular lip 115 extending forward from the annular flange 114 and circumferentially around a portion of the annular flange 114. That is, in one or more embodiments, the status indicator light assembly 100 may include the visor 113 protruding from the periphery of the status light 102 in the primary direction of light emission such that the visor 113 may reduce the spread of emitted light and block or substantially block light from being seen by other drivers that may be to the side of the trailer 700. This reduces the risk of the status light 102 impairing the vision of other drivers and improves overall road safety. Additionally, the visor 113 may make it easier for the truck driver to see the status light 102 in the side view mirror 801.

The status light 102 may be any suitable type or kind of light, such as a light emitting diode (LED) light. Additionally, in one or more embodiments the status light 102 may be a mono-color light configured to emit a single color of light, although in one or more embodiments the status light 102 may be a multi-color light configured to emit two or more different colors of light (e.g., red or green). Furthermore, although in the illustrated embodiment the status light 102 is round (e.g., circular), in one or more embodiments the status light 102 may have any other suitable shape, such as square or rectangular. In one or more embodiments, the status light 102 may be controlled by a circuit that is configured to illuminate the status light 102 in response to the detection of an issue (e.g., a failure, an error, or other irregularity or abnormality) with the electrical system of the trailer 700, such as the reefer or the ATIS. In one or more embodiments, the status light 102 may be controlled by a circuit that is configured to detect the ambient light level and to adjust the output of the light emitted by the status light 102 to reduce (mitigate) the possibility that the light emitted from the status light 102 will distract the driver or other drivers around the trailer 700 (e.g., the circuit may be configured to increase the intensity of the light emitted from the status light 102 in response to relatively brighter ambient light conditions and to reduce the intensity of the light emitted from the status light 102 in response to relatively darker ambient light conditions).

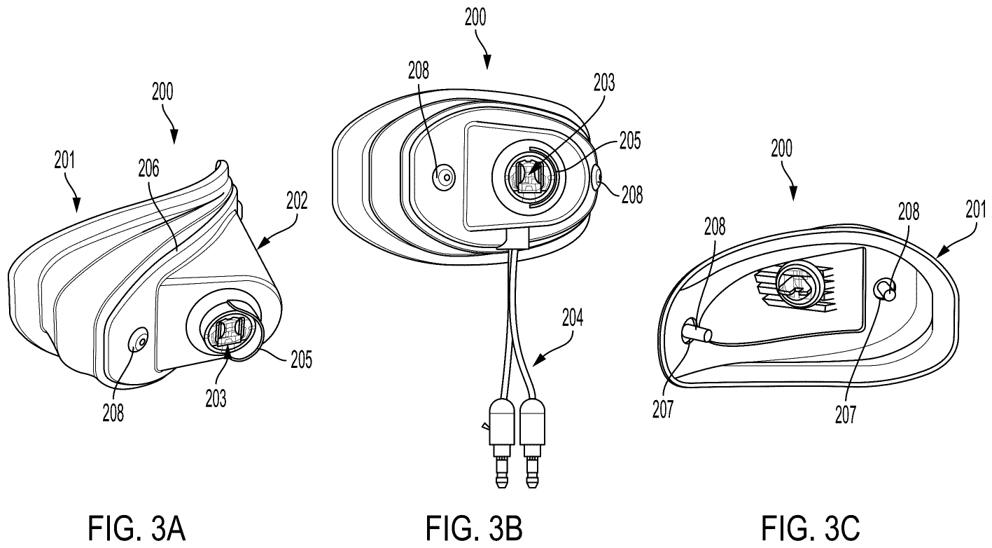

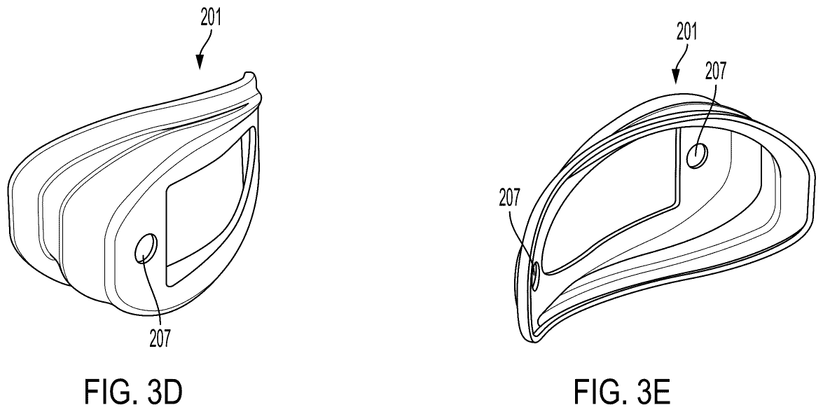

With reference now to FIGS. 3A-3C, a status indicator light assembly 200 according to another embodiment of the present disclosure includes a flexible gasket 201, a housing 202, a status light 203, a wiring harness 204, and a visor 205. In one or more embodiments, the configurations of the housing 202, the status light 203, the wiring harness 204, and the visor 205 may be the same as the configurations of the housing 101, the status light 102, the wiring harness 103, and the visor 113, respectively, in the embodiment depicted in FIGS. 2A-2E and therefore the descriptions of these components will not be repeated.

In the illustrated embodiment, the flexible gasket 201 is between the housing 202 and the corner 701 of the trailer 700. In one or more embodiments, the gasket 201 is configured to fill and seal the space between the curved interface surface 206 of the housing 202 and the curved exterior surface of the corner 701 of the trailer 700. The flexible gasket 201 is configured to conform (or substantially conform) to a range of different corner curvatures, thereby allowing the status indicator light assembly 200 to be mounted to a variety of trailers 700 with different corner configurations (e.g., sizes and/or shapes). For instance, in one or more embodiments, the flexible gasket 201 may be configured to allow the status indicator light assembly 200 to be mounted to a trailer 700 in which the configuration (e.g., size and shape) of a curved interface surface 206 of the housing 202 (akin to the interface surface 106 of the housing 101 in FIGS. 2A-2E) does not match or does not substantially match the configuration (e.g., size and shape) of the corner 701 of the trailer 700. In one or more embodiments, the flexible gasket 201 may be hollow. In one or more embodiments, the flexible gasket 201 may be an accordion gasket. In one or more embodiments, the gasket 201 may taper from a thicker front-end portion to a thinner rear-end portion. The gasket 201 may include an elastomeric material or the like. Additionally, in one or more embodiments, the gasket 201 includes a plurality of holes 207 (e.g., a front hole and a rear hole) configured to accommodate fasteners 208 (e.g., rivets or screws) to attach the housing 202 to the trailer 700. In one or more embodiments in which the gasket 201 tapers from a thicker front-end portion to a thinner rear-end portion, a front one of the fasteners 208 (e.g., a front screw or rivet) may be longer than a rear one of the fasteners 208 (e.g., a rear screw or rivet). In one or more embodiments, a cut-to-length tube spacer with a screw or a stackable shim may be used.

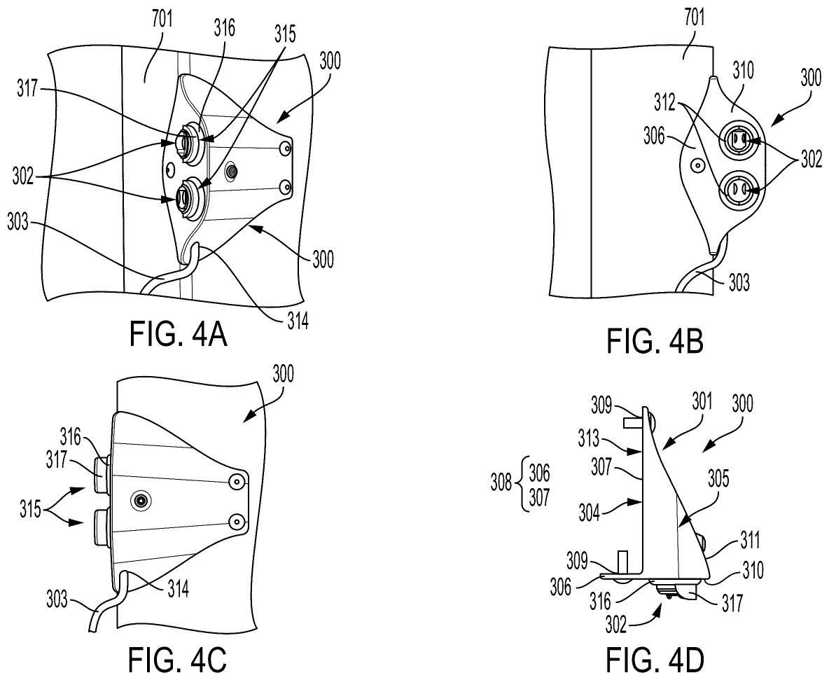

With reference now to FIGS. 4A-4D, a status indicator light assembly 300 according to one embodiment includes a housing 301, two status lights 302 supported by the housing 301, and a wiring harness 303 connected to the status lights 302. In the illustrated embodiment, the housing 301 includes a mounting member 304 and a support member 305 connected to the mounting member 304. The mounting member 304 includes a lateral flange 306 and a longitudinal flange 307 extending rearward from the lateral flange 306. The mounting member 304 also includes an inner angled interface surface 308 configured to face toward one of the front corners 701 of the trailer 700. In one or more embodiments, the inner angled interface surface 308 extends across the lateral flange 306 and the longitudinal flange 307. In one or more embodiments, when the status indicator light assembly 300 is installed on one of the corners 701 of the trailer 700, the angled interface surface 308 may directly or indirectly contact one of the corners 701 of the trailer 700. In one or more embodiments, the angled interface surface 308 of the housing 301 may be configured to conform (or substantially conform) to one of the front corners 701 of the trailer 700 (e.g., the driver side front corner 701 of the trailer 700). That is, in one or more embodiments, the configuration (e.g., the shape and size) of the angled interface surface 308 may match or substantially match the configuration (e.g., shape and size) of one of the corners 701 of the trailer 700. In one or more embodiments, the angled interface surface 308 may be a right-angle surface or substantially a right-angle surface (e.g., the lateral flange 306 may be perpendicular or substantially perpendicular to the longitudinal flange 307) such that the mounting member 304 has an L-shape. In one or more embodiments, the angled interface surface 308 may be an acute angle or an obtuse angle. In one or more embodiments, the status indicator light assembly 300 may be utilized when the front corner 701 of the trailer 700 is sharp or angled (e.g., a substantially square corner). Because trailers may be manufactured with different corner angles, the housing 301 may be provided in different versions, each having an angled interface surface 308 that matches or substantially matches the corner angle of the trailer 700 for which it is intended.

In the illustrated embodiment, the housing 301 includes a plurality of openings (e.g., holes) 309 in the mounting member 304 that are configured to accommodate fasteners (e.g., rivets) securing the housing 301 to the trailer 700. Although in the illustrated embodiment the housing 101 includes three openings 309 (one opening in the lateral flange 306 and two openings in the longitudinal flange 307), in one or more embodiments the housing 301 may include any other suitable number and arrangement of openings 309 for receiving fasteners to secure the housing 301 to the trailer 700.

In the illustrated embodiment, the support member 305 includes a substantially planar surface 310 extending outward from the mounting member 304 and substantially co-planar with the lateral flange 306, and a tapered surface 311 extending rearward from the substantially planar surface 310. A pair of openings 312 (e.g., holes) are defined in the substantially planar surface 310 of the support member 305. The openings 312 accommodate the status lights 302. The support member 305 also defines an interior chamber or compartment 313 configured to house a portion of the status lights 302 and a portion of the wiring harness 303 connected to the status lights 302. For instance, in the illustrated embodiment, the substantially planar surface 310 and the tapered surface 311 together form the interior chamber 313.

In the illustrated embodiment, the housing 301 includes a conduit or channel 314 that places the interior chamber 313 in communication with the exterior of the housing 301. The conduit 314 defines a pathway through which the wiring harness 303 passes from the interior chamber 313 to the exterior of the status indicator light assembly 300. In this manner, the conduit 314 enables the wiring harness 303 to be connected at one end to the status lights 302 and at the other end to one or more electrical systems of the trailer 700, such as the reefer or the ATIS. Although in the illustrated embodiment the conduit 314 is along a lower portion of the support member 305, in one or more embodiments the conduit 314 may be in any other suitable location, such as along an upper portion of the support member 305 or a rear portion of the support member 305.

In the illustrated embodiment, the status indicator light assembly 300 also includes a pair of visors 315 configured to cover or conceal a portion of the status lights 302. The visors 315 are configured to direct the light emitted from the status lights 302 forward toward the tractor 800 and/or to prevent (or at least mitigate) light emitted from the status lights 302 from extending laterally outward away from the trailer 700, which could otherwise obstruct or impair the vision of drivers driving in the opposite direction (i.e., opposing traffic). In the illustrated embodiment, the visors 315 are supported on the support member 305 of the housing 301. In one or more embodiments, at least a portion of the visors 315 may be accommodated in the openings 312 in the support member 305. In the illustrated embodiment, each of the visors 315 includes an annular flange 316 accommodated in one of the openings 312 and a semi-annular lip 317 extending forward from the annular flange 316 and circumferentially around a portion of the annular flange 316. That is, in one or more embodiments, the status indicator light assembly 300 may include the visors 315 protruding from the periphery of the status lights 302 in the primary direction of light emission such that the visors 315 may reduce the spread of emitted light and block or substantially block light from being seen by other drivers that may be to the side of the trailer 700. This reduces the risk of the status lights 302 impairing the vision of other drivers and improves overall road safety. Additionally, the visors 315 may make it easier for the truck driver to see the status lights 302 in the side view mirror 801.

The status lights 302 may be any suitable type or kind of lights, such as light emitting diode (LED) lights. Additionally, in one or more embodiments each of the status lights 302 may be a mono-color light configured to emit a single color of light, although in one or more embodiments the status lights 102 may be a multi-color light configured to emit two or more different colors of light (e.g., red or green). For instance, in one or more embodiments, one of the status lights 302 may be a green light and the other one of the status lights 302 may be a red light or an amber light. Furthermore, although in the illustrated embodiment the status lights 302 are round (e.g., circular), in one or more embodiments the status lights 302 may have any other suitable shape, such as square or rectangular. In one or more embodiments, the status lights 302 may be controlled by a circuit that is configured to illuminate at least one of the lights (e.g., the red light or the amber light) in response to the detection of an issue (e.g., a failure, an error, or other irregularity or abnormality) with the electrical system of the trailer 700. In one or more embodiments, the status lights 302 may be controlled by a circuit that is configured to illuminate at least one of the lights (e.g., the green light) in response to the detection of normal operating conditions of the electrical system of the trailer 700. In one or more embodiments, the status lights 302 may be controlled by a circuit that is configured to detect the ambient light level and to adjust the output of the light emitted by the status lights 302 to reduce (mitigate) the possibility that the light emitted from the status light 302 will distract the driver or other drivers around the trailer 700 (e.g., the circuit may be configured to increase the intensity of the light emitted from the status lights 302 in response to relatively brighter ambient light conditions and to reduce the intensity of the light emitted from the status light 302 in response to relatively darker ambient light conditions). In one or more embodiments, the status lights 302 may be configured to illuminate in response to the status of a single electrical system of the trailer 700 (e.g., the reefer or the ATIS) or two or more electrical systems of the trailer 700 (e.g., both the reefer and the ATIS).

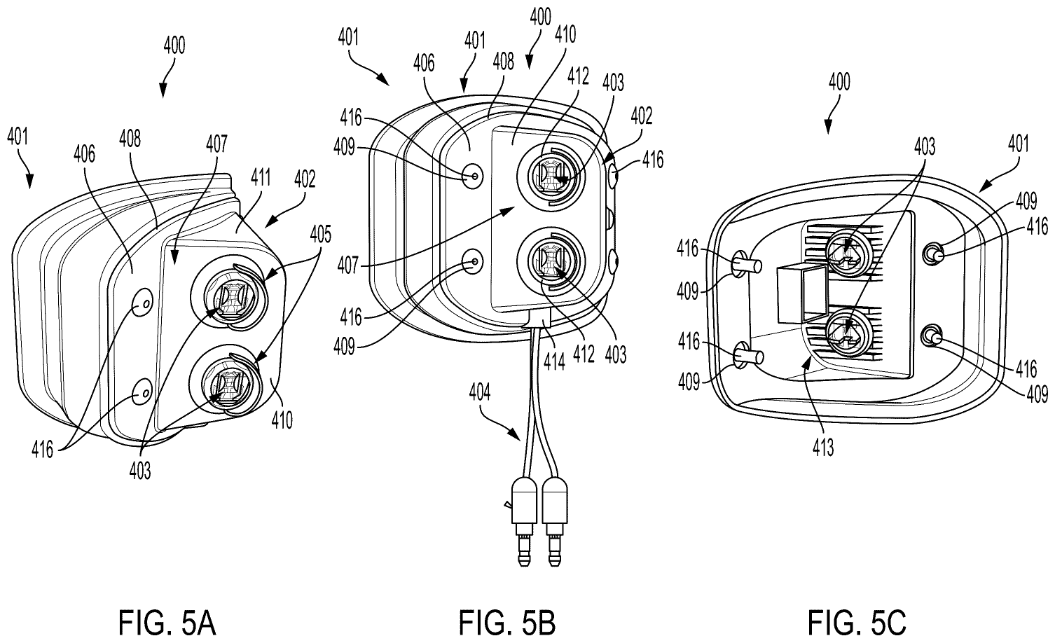

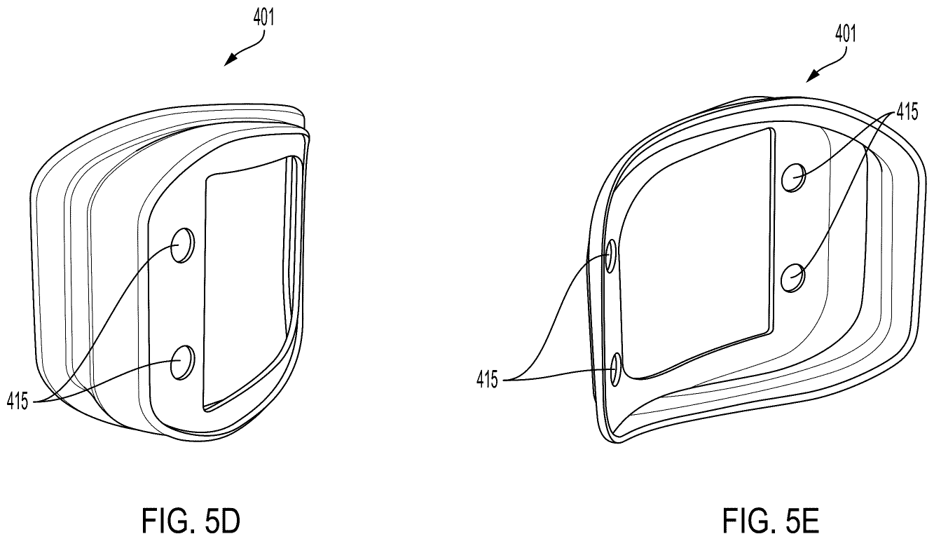

With reference now to FIGS. 5A-5C, a status indicator light assembly 400 according to another embodiment of the present disclosure includes a flexible gasket 401, a housing 402, two status lights 403 supported by the housing 402, a wiring harness 404 connected to the status lights 403, and two visors 405. In one or more embodiments, the configurations of the status lights 403, the wiring harness 404, and the visors 405 may be the same as the configurations of the status light 102, the wiring harness 103, and the visor 113, respectively, in the embodiment depicted in FIGS. 2A-2E and therefore the descriptions of these components will not be repeated.

In the illustrated embodiment, the housing 402 includes a mounting flange 406 and a support member 407 connected to the mounting flange 406. The mounting flange 406 includes an inner curved interface surface 408 configured to face toward one of the front corners 701 of the trailer 700. In one or more embodiments, when the status indicator light assembly 400 is installed on one of the corners 701 of the trailer 700, the curved interface surface 408 may directly or indirectly contact one of the corners 701 of the trailer 700. In one or more embodiments, the curved interface surface 408 of the housing 402 may be configured to conform (or substantially conform) to one of the front corners 701 of the trailer 700 (e.g., the driver side front corner 701 of the trailer 700). That is, in one or more embodiments, the configuration (e.g., the shape and size) of the curved interface surface 408 may match or substantially match the configuration (e.g., shape and size) of one of the corners 701 of the trailer 700. In one or more embodiments, the curved interface surface 106 may be a radiused surface. Because trailers may be manufactured with different corner curvatures, the housing 402 may be provided in different versions, each having a curved interface surface 408 that matches or substantially matches the corner curvature of the trailer 700 for which it is intended.

In the illustrated embodiment, the housing 402 includes a plurality of openings (e.g., holes) 409 in the mounting flange 406 that are configured to accommodate fasteners (e.g., rivets) securing the housing 402 to the trailer 700. Although in the illustrated embodiment the housing 402 includes four openings 409 (a pair of front openings and a pair of rear openings), in one or more embodiments the housing 402 may include any other suitable number and arrangement of openings 409 for receiving fasteners to secure the housing 402 to the trailer 700.

In the illustrated embodiment, the support member 407 includes a substantially planar surface 410 extending outward from the mounting flange 406, and a tapered surface 411 extending rearward from the substantially planar surface 410. A pair of openings 412 (e.g., a pair of holes) are defined in the substantially planar surface 410 of the support member 407. The openings 412 accommodate the status lights 403. The support member 407 also defines an interior chamber or compartment 413 configured to house a portion of the status lights 403 and a portion of the wiring harness 404 connected to the status lights 403. For instance, in the illustrated embodiment, the substantially planar surface 410 and the tapered surface 411 together form the interior chamber 413.

In the illustrated embodiment, the housing 402 includes a conduit or channel 414 that places the interior chamber 413 in communication with the exterior of the housing 402. The conduit 414 defines a pathway through which the wiring harness 404 passes from the interior chamber 413 to the exterior of the status indicator light assembly 400. In this manner, the conduit 414 enables the wiring harness 404 to be connected at one end to the status lights 403 and at the other end to one or more electrical systems of the trailer 700, such as the reefer or the ATIS. Although in the illustrated embodiment the conduit 414 is along a lower portion of the mounting flange 406 below the support member 407, in one or more embodiments the conduit 414 may be in any other suitable location, such as along an upper portion of the mounting flange 406 above the support member 407 or rearward of the support member 407.

In the illustrated embodiment, the flexible gasket 401 is between the housing 402 and the corner 701 of the trailer 700. In one or more embodiments, the gasket 401 is configured to fill and seal the space between the curved interface surface 408 of the housing 402 and the curved exterior surface of the corner 701 of the trailer 700. The flexible gasket 401 is configured to conform (or substantially conform) to a range of different corner curvatures, thereby allowing the status indicator light assembly 400 to be mounted to a variety of trailers 700 with different corner configurations (e.g., sizes and/or shapes). For instance, in one or more embodiments, the flexible gasket 401 may be configured to allow the status indicator light assembly 400 to be mounted to a trailer 700 in which the configuration (e.g., size and shape) of a curved interface surface 408 of the housing 402 does not match or does not substantially match the configuration (e.g., size and shape) of the corner 701 of the trailer 700. In one or more embodiments, the flexible gasket 401 may be hollow. In one or more embodiments, the flexible gasket 401 may be an accordion gasket. In one or more embodiments, the gasket 401 may taper from a thicker front-end portion to a thinner rear-end portion. The gasket 401 may include an elastomeric material or the like. Additionally, in one or more embodiments, the gasket 401 includes a plurality of holes 415 (e.g., a pair of front holes and a pair of rear holes) configured to accommodate fasteners 416 (e.g., rivets or screws) to attach the housing 402 to the trailer 700. In one or more embodiments in which the gasket 401 tapers from a thicker front-end portion to a thinner rear-end portion, a front pair of the fasteners 416 (e.g., a front pair of screws or rivets) may be longer than a rear pair of the fasteners 416 (e.g., a rear pair of screws or rivets). In one or more embodiments, a cut-to-length tube spacer with a screw or a stackable shim may be used.

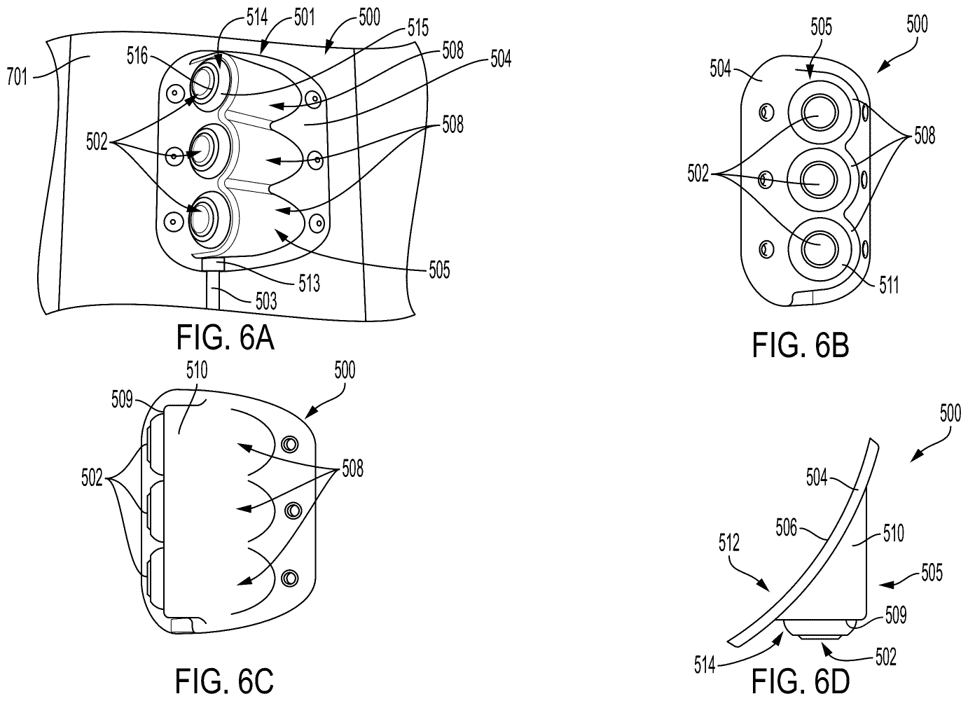

With reference now to FIGS. 6A-6D, a status indicator light assembly 500 according to one embodiment includes a housing 501, three status lights 502 supported by the housing 501, and a wiring harness 503 connected to the status lights 502. In the illustrated embodiment, the housing 501 includes a mounting member 504 (e.g., a mounting flange) and a support member 505 connected to the mounting member 504. The mounting member 504 includes an inner curved interface surface 506 configured to face toward one of the front corners 701 of the trailer 700. In one or more embodiments, when the status indicator light assembly 500 is installed on one of the corners 701 of the trailer 700, the curved interface surface 506 may directly or indirectly contact one of the corners 701 of the trailer 700. In one or more embodiments, the curved interface surface 506 of the housing 501 may be configured to conform (or substantially conform) to one of the front corners 701 of the trailer 700 (e.g., the driver side front corner 701 of the trailer 700). That is, in one or more embodiments, the configuration (e.g., the shape and size) of the curved interface surface 506 may match or substantially match the configuration (e.g., shape and size) of one of the corners 701 of the trailer 700. In one or more embodiments, the curved interface surface 506 may be a radiused surface. Because trailers may be manufactured with different corner curvatures, the housing 501 may be provided in different versions, each having a curved interface surface 506 that matches or substantially matches the corner curvature of the trailer 700 for which it is intended.

In the illustrated embodiment, the housing 501 includes a plurality of openings (e.g., holes) 507 in the mounting flange 504 that are configured to accommodate fasteners (e.g., rivets) securing the housing 501 to the trailer 700. Although in the illustrated embodiment the housing 501 includes six openings 507 (three front openings and three rear openings), in one or more embodiments the housing 501 may include any other suitable number and arrangement of openings 507 for receiving fasteners to secure the housing 501 to the trailer 700.

In the illustrated embodiment, the support member 505 includes three semi-cylindrical projections 508. The semi-cylindrical projections 508 may be connected to each other or disconnected from each other. In the illustrated embodiment, each semi-cylindrical projection 508 includes a substantially planar surface 509 and a tapered surface 510 extending rearward from the substantially planar surface 509. Additionally, in the illustrated embodiment, the housing 501 includes three openings (e.g., three holes) 511 in the three semi-cylindrical projections 508 (e.g., one opening 511 in the substantially planar surface 509 of each semi-cylindrical projection 508). The openings 511 accommodate the status lights 502. The support member 505 also defines an interior chamber or compartment 512 configured to house a portion of the status lights 502 and a portion of the wiring harness 503 connected to the status lights 502. For instance, in the illustrated embodiment, the substantially planar surfaces 509 and the tapered surfaces 510 of the semi-cylindrical projections 508 together form the interior chamber 512.

In the illustrated embodiment, the housing 501 includes a conduit or channel 513 that places the interior chamber 512 in communication with the exterior of the housing 501. The conduit 513 defines a pathway through which the wiring harness 503 passes from the interior chamber 512 to the exterior of the status indicator light assembly 500. In this manner, the conduit 513 enables the wiring harness 503 to be connected at one end to the status lights 502 and at the other end to one or more electrical systems of the trailer 700, such as the reefer or the ATIS. Although in the illustrated embodiment the conduit 513 is along a lower portion of the mounting flange 504 below the support member 505, in one or more embodiments the conduit 513 may be in any other suitable location, such as along an upper portion of the mounting flange 504 above the support member 505 or rearward of the support member 505.

In the illustrated embodiment, the status indicator light assembly 500 also includes three visors 514 configured to cover or conceal a portion of the status lights 502. The visors 514 are configured to direct the light emitted from the status lights 502 forward toward the tractor 800 and/or to prevent (or at least mitigate) light emitted from the status lights 502 from extending laterally outward away from the trailer 700, which could otherwise obstruct or impair the vision of drivers driving in the opposite direction (i.e., opposing traffic). In the illustrated embodiment, the visors 514 are supported on the support member 505 of the housing 501. In one or more embodiments, at least a portion of the visors 514 may be accommodated in the openings 511 in the support member 505. In the illustrated embodiment, each of the visors 514 includes an annular flange 515 accommodated in the opening 511 and a semi-annular lip 516 extending forward from the annular flange 515 and circumferentially around a portion of the annular flange 515. That is, in one or more embodiments, the status indicator light assembly 500 may include the visors 514 protruding from the periphery of the status lights 502 in the primary direction of light emission such that the visors 514 may reduce the spread of emitted light and block or substantially block light from being seen by other drivers that may be to the side of the trailer 700. This reduces the risk of the status lights 502 impairing the vision of other drivers and improves overall road safety. Additionally, the visors 514 may make it easier for the truck driver to see the status light 102 in the side view mirror 801.

The status lights 502 may be any suitable type or kind of lights, such as light emitting diode (LED) lights. Additionally, in one or more embodiments each of the status lights 502 may be a mono-color light configured to emit a single color of light, although in one or more embodiments the status lights 502 may be a multi-color light configured to emit two or more different colors of light (e.g., red or green). For instance, in one or more embodiments, one of the status lights 502 may be a green light, another one of the status lights 502 may be a red light or an amber light, and a further one of the status lights 502 may be a white light. Furthermore, although in the illustrated embodiment the status lights 502 are round (e.g., circular), in one or more embodiments the status lights 502 may have any other suitable shape, such as square or rectangular. In one or more embodiments, the status lights 502 may be controlled by a circuit that is configured to illuminate at least one of the lights (e.g., the red light or the amber light) in response to the detection of an issue (e.g., a failure, an error, or other irregularity or abnormality) with the electrical system of the trailer 700. In one or more embodiments, the status lights 502 may be controlled by a circuit that is configured to illuminate at least one of the lights (e.g., the green light) in response to the detection of normal operating conditions of the electrical system of the trailer 700. In one or more embodiments, the status lights 502 may be controlled by a circuit that is configured to detect the ambient light level and to adjust the output of the light emitted by the status lights 502 to reduce (mitigate) the possibility that the light emitted from the status light 502 will distract the driver or other drivers around the trailer 700 (e.g., the circuit may be configured to increase the intensity of the light emitted from the status lights 502 in response to relatively brighter ambient light conditions and to reduce the intensity of the light emitted from the status light 502 in response to relatively darker ambient light conditions). In one or more embodiments, the status lights 502 may be configured to illuminate in response to the status of a single electrical system of the trailer 700 or two or more electrical systems of the trailer 700. In one or more embodiments, two of the status lights 502 may be utilized to indicate the status of a trailer reefer and the remaining status light 502 may be utilized to indicate the status of the trailer ATIS.

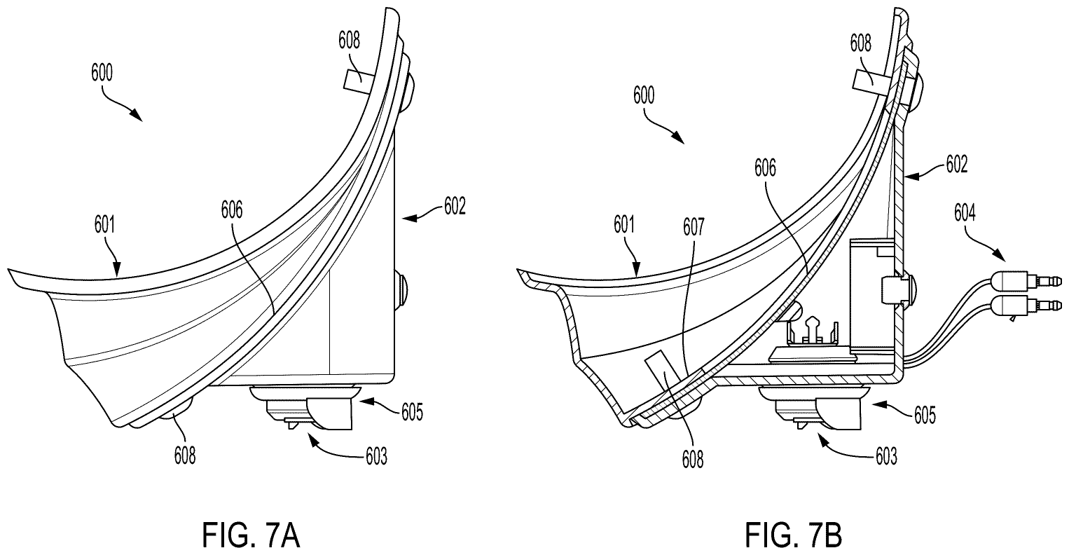

With reference now to FIGS. 7A-7B, a status indicator light assembly 600 according to another embodiment of the present disclosure includes a flexible gasket 601, a housing 602, three status lights 603, a wiring harness 604, and three visors 605. In one or more embodiments, the configurations of the housing 602, the status lights 603, the wiring harness 604, and the visors 605 may be the same as the configurations of the housing 501, the status lights 502, the wiring harness 503, and the visors 514, respectively, in the embodiment depicted in FIGS. 6A-6D and therefore the descriptions of these components will not be repeated.

In the illustrated embodiment, the flexible gasket 601 is between the housing 602 and the corner 701 of the trailer 700. In one or more embodiments, the gasket 601 is configured to fill and seal the space between a curved interface surface 606 of the housing 602 and the curved exterior surface of the corner 701 of the trailer 700. The flexible gasket 601 is configured to conform (or substantially conform) to a range of different corner curvatures, thereby allowing the status indicator light assembly 600 to be mounted to a variety of trailers 700 with different corner configurations (e.g., sizes and/or shapes). For instance, in one or more embodiments, the flexible gasket 601 may be configured to allow the status indicator light assembly 600 to be mounted to a trailer 700 in which the configuration (e.g., size and shape) of the curved interface surface 606 of the housing 602 (akin to the interface surface 506 of the housing 501 in FIGS. 6A-6D) does not match or does not substantially match the configuration (e.g., size and shape) of the corner 701 of the trailer 700. In one or more embodiments, the flexible gasket 601 may be hollow. In one or more embodiments, the flexible gasket 601 may be an accordion gasket. In one or more embodiments, the gasket 601 may taper from a thicker front-end portion to a thinner rear-end portion. The gasket 601 may include an elastomeric material or the like. Additionally, in one or more embodiments, the gasket 601 includes a plurality of holes 607 (e.g., a front hole and a rear hole) configured to accommodate fasteners 608 (e.g., rivets or screws) to attach the housing 602 to the trailer 700. In one or more embodiments in which the gasket 601 tapers from a thicker front-end portion to a thinner rear-end portion, a front one of the fasteners 608 (e.g., a front screw or rivet) may be longer than a rear one of the fasteners 208 (e.g., a rear screw or rivet). In one or more embodiments, a cut-to-length tube spacer with a screw or a stackable shim may be used.

Accordingly, as provided above, in some embodiments, the status indicator light assembly allows for real-time monitoring of the various electrical systems of a trailer, such as a reefer, an ATIS, or the like, while the vehicle is in motion. Although the above-described embodiments include either a single status indicator light, a pair of status indicator lights, or three indicator lights, in one or more embodiments the status indicator light assembly may include any other suitable number of status indicator lights, such as more than three status indicator lights. Additionally, the status indicator light assemblies of the present disclosure may be utilized to monitor the status of a single electrical system of the trailer or the status of two or more electrical systems of the trailer, such as both the reefer and the ATIS.

Additionally, features from the various embodiments described above can be combined in any suitable way to make another embodiment of the present disclosure. For instance, the embodiment of the status indicator light assembly 300 depicted in FIGS. 4A-4D may be modified to include a flexible gasket (e.g., similar to the flexible gasket shown in FIGS. 5A-5E) between the housing 301 and the corner 701 of the trailer 700. Furthermore, the embodiments of the status indicator light assemblies 100, 200, 300, 400, 500, or 600 may be modified to include any other suitable number of status lights, such as a single status light, two status lights, three status lights, or more than three status lights.

While this invention has been described in detail with particular references to illustrative embodiments thereof, the embodiments described herein are not intended to be exhaustive or to limit the scope of the invention to the exact forms disclosed. Persons skilled in the art and technology to which this invention pertains will appreciate that alterations and changes in the described structures and methods of operation can be practiced without meaningfully departing from the principles, spirit, and scope of this invention, as set forth in the following claims and equivalents thereof.

The terms used in the present specification are used to describe particular embodiments, and are not intended to limit the present invention. For example, an expression used in the singular encompasses the expression of the plural, unless it has a clearly different meaning in the context. In the present specification, it is to be understood that the terms such as “comprising,” “including,” “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

As used herein, the term “and/or” includes any and all combinations of one or more of the associated listed items.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Further, when describing embodiments of the present invention, the use of “may” relates to “one or more embodiments of the present invention.”

As used herein, the term “substantially,” “about,” and similar terms are used as terms of approximation and not as terms of degree, and are intended to account for the inherent deviations in measured or calculated values that would be recognized by those of ordinary skill in the art. Also, the terms “use,” “using,” and “used” may be considered synonymous with the terms “utilize,” “utilizing,” and “utilized,” respectively.

What is claimed is:

1. A status indicator light assembly for a trailer, the status indicator light assembly comprising:
a housing comprising:
a mounting member having an interface surface configured to face a portion of a corner of the trailer;
a support member connected to the mounting member; and
at least one opening in the support member;
at least one status light accommodated in the at least one opening of the housing; and
a wiring harness having one end coupled to the at least one status light and another end configured to be coupled to an electrical system of the trailer.

2. The status indicator light assembly of claim 1, wherein the interface surface is a curved surface.

3. The status indicator light assembly of claim 2, wherein the curved surface is a radiused surface.

4. The status indicator light assembly of claim 1, wherein the interface surface is an angled surface.

5. The status indicator light assembly of claim 1, further comprising at least one visor accommodated in the at least one opening, the at least one visor covering at least a portion of an outer side of the at least one status light.

6. The status indicator light assembly of claim 5, wherein the at least one visor comprises an annular flange accommodated in the at least one opening and a semi-annular lip extending forward from the annular flange and circumferentially around a portion of the annular flange.

7. The status indicator light assembly of claim 1, further comprising a flexible gasket configured to be coupled to the interface surface of the housing.

8. The status indicator light assembly of claim 7, wherein the flexible gasket is an accordion gasket.

9. The status indicator light assembly of claim 8, wherein the flexible gasket tapers from a thicker front-end portion to a thinner rear-end portion.

10. The status indicator light assembly of claim 9, wherein the flexible gasket is hollow.

11. The status indicator light assembly of claim 1, wherein the at least one status light comprises a plurality of status lights.

12. The status indicator light assembly of claim 11, wherein the support member comprises a plurality of semi-cylindrical projections, each semi-cylindrical projection of the plurality of semi-cylindrical projections supporting one of the plurality of status lights.

13. The status indicator light assembly of claim 1, further comprising a plurality of fastener openings in the mounting member of the housing.

14. The status indicator light assembly of claim 1, wherein the support member of the housing comprises a substantially planar surface and a tapered surface extending rearward from the substantially planar surface.

15. A method of retrofitting a trailer to include the status indicator light assembly of claim 1, the method comprising:
fastening the mounting member of the housing to the corner of the trailer such that the at least one status light is oriented in a forward direction toward a tractor towing the trailer;
connecting the another end of the wiring harness to the electrical system of the trailer.

16. The method of claim 15, wherein the electrical system is a reefer.

17. The method of claim 15, wherein the electrical system is an automatic tire inflation system.

18. The method of claim 15, wherein the fastening comprises riveting the mounting member to the corner of the trailer.

19. The method of claim 15, wherein the interface surface of the mounting member substantially conforms to the corner of the trailer.

20. The method of claim 15, wherein a shape of the interface surface is different than a shape of the corner, and wherein the method further comprises installing a flexible gasket between the interface surface of the housing and the corner of the trailer.
